(19) United States
(12) Patent Application Publication
(10) Pub. No.: US 2017/0109250 A1
(43) Pub. Date: Apr. 20, 2017

(54) MONITORING APPARATUS, METHOD OF MONITORING AND NON-TRANSITORY COMPUTER-READABLE STORAGE MEDIUM

(71) Applicant: FUJITSU LIMITED, Kawasaki-shi (JP)

(72) Inventor: Tatsuma MATSUKI, Kawasaki (JP)

(73) Assignee: FUJITSU LIMITED, Kawasaki-shi (JP)

(21) Appl. No.: 15/293,518

(22) Filed: Oct. 14, 2016

(30) Foreign Application Priority Data
Oct. 20, 2015 (JP) 2015-206650

(51) Int. Cl. G06F 11/34; G06F 17/18; G06F 9/455

(52) U.S. Cl. CPC G06F 11/3409; G06F 9/45558; G06F 17/18; G06F 2009/45595

(57) ABSTRACT

A monitoring apparatus includes a memory, and a processor configured to obtain a plurality of first measurement results relating to a first performance of an application and a plurality of second measurement results relating to a second performance of the infrastructure when the application is executed by using the infrastructure, classify the plurality of first measurement results into a plurality of groups, determine a first mean value of one or more of the plurality of first measurement results which are included in each of the group, and determine a second mean value of one or more of the plurality of second measurement results which are associated with the one or more first measurement results included in the group, and execute regression analysis based on a plurality of the first mean values and a plurality of the second mean values for the plurality of groups.

### CROSS-REFERENCE TO RELATED APPLICATION

This application is based upon and claims the benefit of priority of the prior Japanese Patent Application No. 2015-206650, filed on Oct. 20, 2015, the entire contents of which are incorporated herein by reference.

### FIELD

The embodiment discussed herein is related to a monitoring apparatus, a method of monitoring and a non-transitory computer-readable storage medium.

### BACKGROUND

Cloud services, which have emerged with developments in virtualization technology, are now used in a very wide range of fields. Meanwhile, virtualized infrastructure systems which provide the cloud services are increasing in scale and complexity in recent years, and handling of troubles such as system abnormality and failures is becoming difficult.

In order to handle system troubles, a manager efficiently analyzes log information, statistical information, configuration information, and the like which are obtained from the system, and quickly indentifies the cause of the troubles and performs repairing. In a large-scale virtualized system, it is difficult to manually analyze all information such as the log information, the statistical information, and the configuration information. Particularly, handling of a trouble in the virtualized system is difficult because it is possible that a trouble is resulting [is caused] from a wide range of layers and such layers are often managed by different administrators.

In a virtualized infrastructure system which provides cloud services, performance items collectable in a virtualized infrastructure (infrastructure) are monitored to check whether the services are safely provided. The infrastructure is, for example, a group of hardware devices such as servers and switches. However, an infrastructure manager may not capable of obtaining information on the performance of an application operating on the virtualized infrastructure. Accordingly, there is known a method of monitoring the performance of the application in which the performance of the application is determined from performance items obtainable on the infrastructure side.

As a method of monitoring the performance, there is known a technique in which a monitoring item is selected by calculating a correlation coefficient between a system performance and a resource item. In this technique, monitoring items with high correlation are selected, then regression analysis is performed, and a monitoring item is selected.

There is known a method of appropriately setting a classification boundary in the case of performing regression analysis of a data set of mixed data groups with different characteristics. The regression analysis is performed by varying the classification boundary as a parameter and selecting a boundary at which an evaluation value is greatest as an optimal boundary.

There is known a regression analysis method as follows. Multiple input variables are provided to form partial least squares method models and the models are created for all input variables. A model with the best statistical index is used as a model for the analysis.

There is also known a method of generating multiple regression models and using a model with a high correlation coefficient. As prior art documents there are Japanese Laid-open Patent Publication Nos. 2003-263342, 10-75218, 2011-242923, and 2002-99448.

### SUMMARY

According to an aspect of the invention, a monitoring apparatus includes a memory, and a processor coupled to the memory and configured to obtain a plurality of first measurement results relating to a first performance of an application when the application is executed by using an infrastructure, obtain a plurality of second measurement results relating to a second performance of the infrastructure when the application is executed by using the infrastructure, the plurality of second measurement results being associated with the plurality of first measurement results respectively, classify the plurality of first measurement results into a plurality of groups, based on values of the first performance, determine, for each of the plurality of groups, a first mean value of one or more of the plurality of first measurement results which are included in the group, and determine a second mean value of one or more of the plurality of second measurement results which are associated with the one or more first measurement results included in the group, execute regression analysis based on a plurality of the first mean values and a plurality of the second mean values for the plurality of groups, and monitor the first performance of the application based on the second measurement results of the second performance, according to a result of the regression analysis.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view for explaining an example of a virtualized infrastructure system;

FIG. 2 is a view for explaining an example of pieces of performance information correlated to each other;

FIG. 3 is a view for explaining an example of a regression analysis result of performance information affected by noises and outliers;

FIG. 4 is a view for explaining an example of processing of generating a regression analysis model in which effects of noises and outliers are reduced in an embodiment;

FIG. 5 is a view for explaining an example of a regression analysis result using a mean value in each divided region;

FIG. 6 is a view for explaining an example of a system configuration in the embodiment;

FIG. 7 is a view for explaining examples of functional blocks of an analysis device;

FIG. 8 is a view for explaining an example of a hardware configuration of the analysis device;

FIG. 9 is a view for explaining an example of contents of application performance information and infrastructure performance information;

FIG. 10 is a view for explaining an example of processing of generating a data pair of the application performance information and the infrastructure performance information;

FIG. 11 is a view for explaining an example of the regression analysis result; and

FIG. 12 is a flowchart for explaining an example of processing of the analysis device.

### DESCRIPTION OF EMBODIMENT

There is known a method in which multiple pieces of performance information collected in an application and multiple pieces of performance information collectable on an infrastructure side are compared with one another to select a monitoring performance item used for performance monitoring of the application. However, the pieces of performance information collected in the application and the infrastructure side includes noises and outliers, and an inappropriate monitoring performance item is selected in some cases.

In the following description, time-series data used as a performance index of the application operating on a virtualized infrastructure system is referred to as “application performance information.” The application performance information includes, for example, response time (in units of seconds and milliseconds), throughput (per unit time), and the like. The application performance information is obtained for each application, and measured and stored each time a response is made to a request to obtain the application performance information. The obtaining request is made by, for example, a monitoring server monitoring the performance information.

Time-series data used as a performance index of the infrastructure such as servers, switches, and the like in the virtualized infrastructure system is referred to as “infrastructure performance information.” The infrastructure performance information is measured in each of the devices such as the servers and the switches at fixed time intervals, and is stored. The infrastructure performance information includes, for example, performance metrics such as a CPU usage (%) and a network throughput (bps).

However, when a noise or an outlier exists in the time-series data, the time-series data of the application performance information and the time-series data of the infrastructure performance information which are strongly correlated to each other may not be correctly extracted. Moreover, in the case where the application performance is desired to be monitored by modeling the correlation between these pieces of performance information by utilizing regression analysis or the like, an accurate model may not be generated when a noise or an outlier exists in the time-series data. In the embodiment described below, processing of reducing effects of a noise in the regression analysis is performed to perform extraction and modeling of the correlation with high accuracy. In the embodiment, infrastructure performance information optimal for the performance monitoring of the application may be selected from multiple pieces of infrastructure performance information.

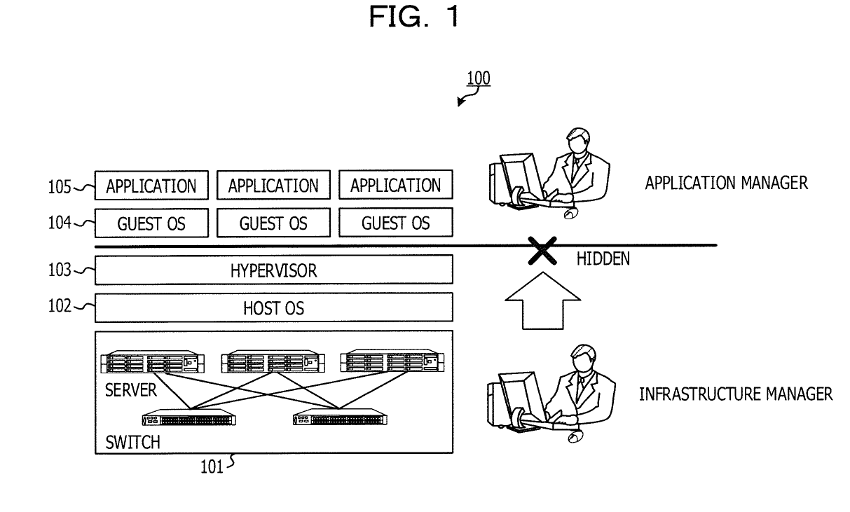

FIG. 1 is a view for explaining an example of the virtualized infrastructure system. The virtualized infrastructure (infrastructure) in the virtualized infrastructure system 100 which provides cloud services includes a hardware group 101 which includes servers, switches, and the like, a host OS 102 which operates on the hardware group 101, a hypervisor 103 which operates on the host OS 102, and the like. Guest OS 104 operates on the virtualized infrastructure and applications 105 operate on the guest OS 104.

In the cloud service, the guest OS 104 is provided to clients. The clients may freely operate applications on the guest OS 104. In an environment such as the virtualized infrastructure system 100, application managers may manage the guest OS 104 and the applications 105.

An infrastructure manager manages the hardware group 101, the host OS 102, the hypervisor 103, and the like. In the virtualized infrastructure system 100 which provides the cloud services, the infrastructure manager does not know what kinds of applications 105 are operating. The infrastructure manager may manage the infrastructure performance information obtained from the hardware group 101, the host OS 102, the hypervisor 103, and the like which are the virtualized infrastructure. Meanwhile, the infrastructure manager is unable to manage the “application performance information” of each application 105. Accordingly, when a trouble occurs in the application 105 and the performance of the application degrades, the infrastructure manager is unable to accurately detect the performance degradation.

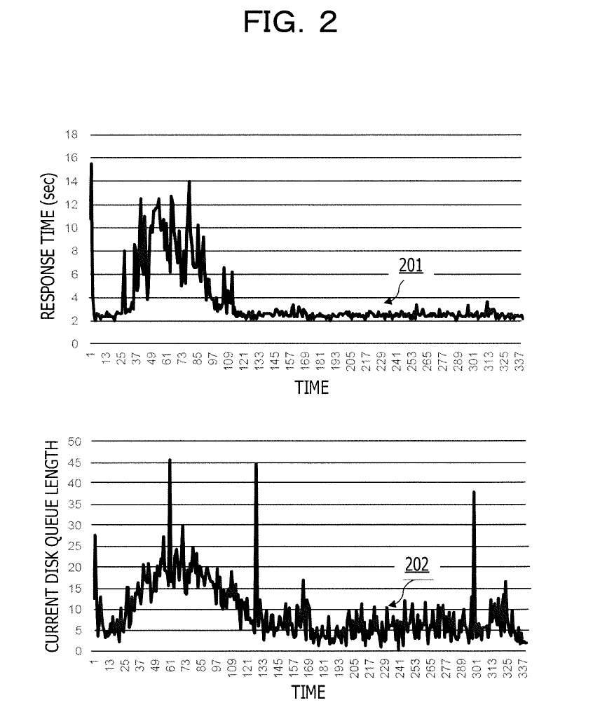

FIG. 2 is a view for explaining an example of pieces of performance information correlated to each other. FIG. 2 depicts an example of time-series data 201 of response time in the application performance information and an example of time-series data 202 of disk queue length (Current Disk Queue Length) in the infrastructure performance information. The response time is an index value of response time for processing of the application. The smaller the index value is, the faster the response is and the higher the performance is. The disk queue length is the number of system requests waiting for disk access. The greater the number of requests is, the greater the number of requests waiting to be processed is and the lower the performance is. In the time-series data 201 of the response time, the vertical axis represents the response time (seconds) and the horizontal axis represents time. In the time-series data 202 of the disk queue length, the vertical axis represents the disk queue length and the horizontal axis represents time. The time in the horizontal axis of the time-series data 201 of the response time and the time in the horizontal axis of the time-series data 202 of the disk queue length are a common time axis.

In view of the time-series data 201 of the response time, the value of the response time increases in a period from time 37 to time 97 on the horizontal axis. In this time period, delay (performance degradation) is occurring in the response processing of the application. Also in the time-series data 202 of the disk queue length, waiting of processing of system requests (performance degradation) is occurring in the same time period. Accordingly, the time-series data 201 of the response time and the time-series data 202 of the disk queue length are apparently correlated to each other.

After time 121 on the horizontal axis in the time-series data 201 of the response time, the index value is 2 to 3 and is stable. Meanwhile, after time 121 on the horizontal axis in the time-series data 202 of the disk queue length, the disk queue length is detected to abruptly increase and decrease between value 0 and value 10. This is due to noises. Moreover, in the time-series data 202 of the disk queue length, large values of disk queue length are detected, for example, at time 133 and time 301. Such large values are referred to as outliers.

There are few noises and outliers like ones described above in the time-series data 201 of the response time. Since the time-series data 202 of the disk queue length includes many noises and outliers, the correlation between the time-series data 201 of the response time and the time-series data 202 of the disk queue length becomes lower. As a result, although the pieces of data are apparently correlated to each other, there occurs a case where a correlation coefficient decreases due to the noises and outliers and the time-series data 202 of the disk queue length is not selected for the performance monitoring of the application.

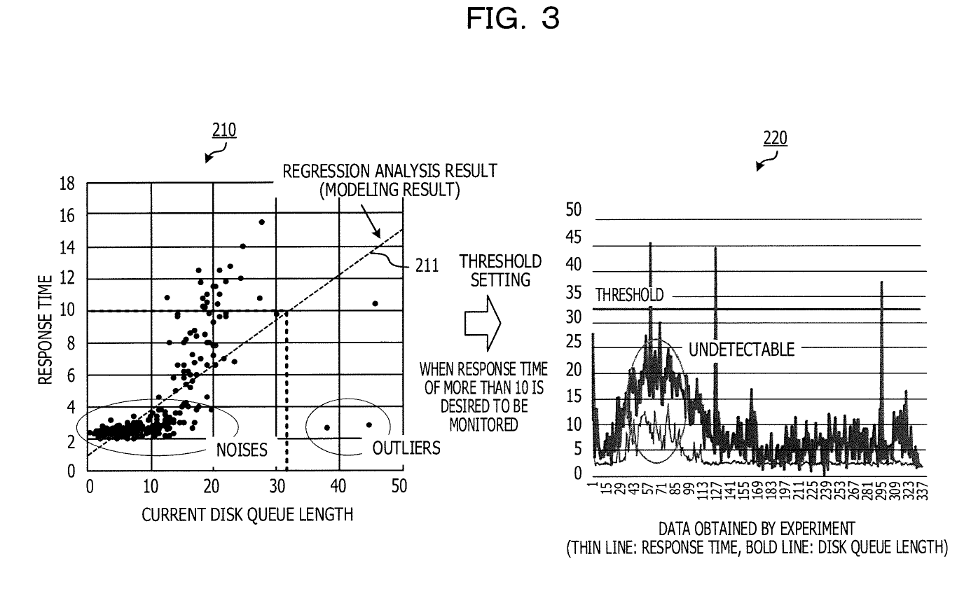

FIG. 3 is a view for explaining an example of a regression analysis result of performance information affected by noises and outliers. A graph 210 depicts relationships between the application performance information and the infrastructure performance information in the same time series. The vertical axis represents the response time in the application performance information and the horizontal axis represents the disk queue length in the infrastructure performance information.

The graph 210 also depicts a regression analysis result 211 obtained by performing regression analysis using the least squares method on the performance data of the response time and the disk queue length. In the graph 210, pieces of performance data are concentrated between the response time of 2 and 4 and between the disk queue length of 0 and 20. These pieces of performance data are obtained due to noises after time 121 on the horizontal axis in the time-series data 202 of the disk queue length in FIG. 2. When the number of pieces of data corresponding to noise portions is great in the graph 210, the regression analysis result 211 is affected by noises.

Assume that cases where the response time is greater than 10 seconds are monitored to monitor the application performance information. Then, the infrastructure manager sets a threshold to, for example, 32 which is the disk queue length in the infrastructure performance information corresponding to the response time of 10 seconds, based on the regression analysis result 211.

A graph 220 includes the time-series data 201 of the response time (thin line) and the time-series data 202 of the disk queue length (bold line). When the disk queue length of 32 in the infrastructure performance information is set as the threshold, it is possible to detect the disk queue length exceeding the threshold only at three points. However, with reference to the graph 210, the number of pieces of the performance data of the response time exceeding 10 seconds is about 20. Accordingly, when the regression analysis result 211 including noises is used, it is difficult to perform accurate monitoring of the application performance information by using the infrastructure performance information. Note that the performance data of short response time and short disk queue length is data of application processing without trouble, and is not performance data desired to be monitored.

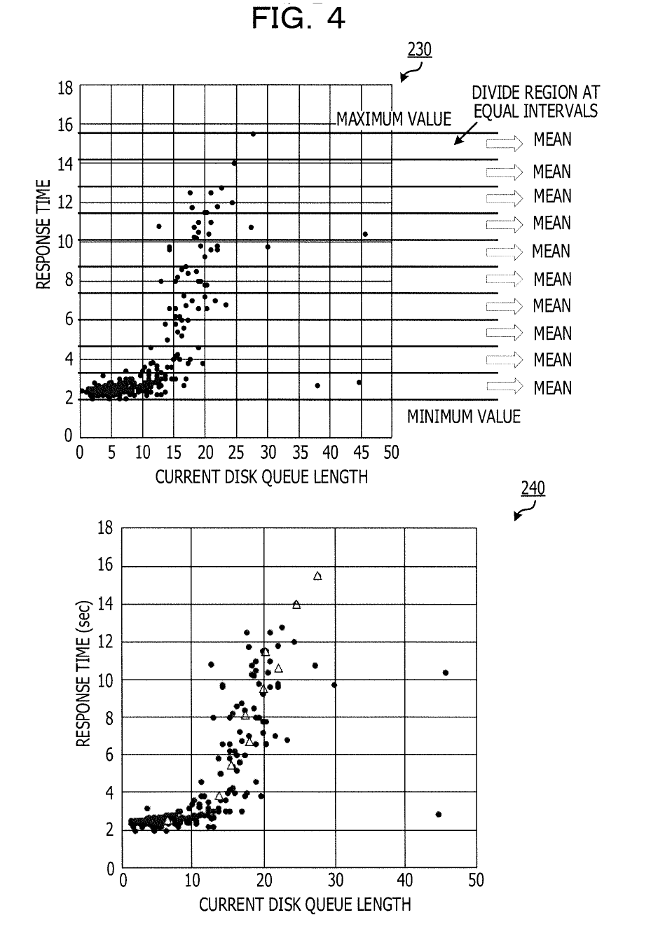

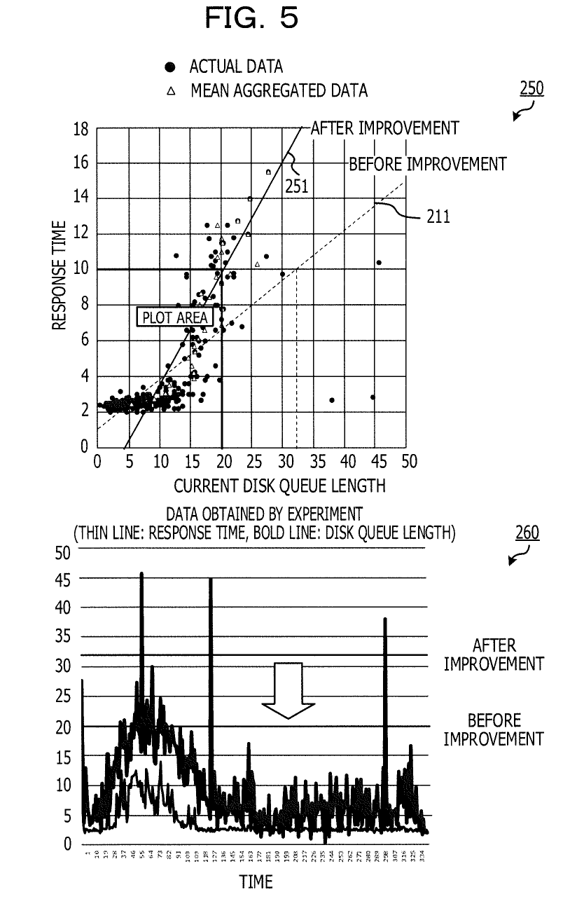

In the embodiment, processing of reducing effects of noises on the regression analysis is performed and the correlation is extracted and modeled with high accuracy. By using FIGS. 4 and 5, description is given below of processing in which the processing of reducing effects of noises on the regression analysis is performed and the correlation is extracted and modeled with high accuracy.

FIG. 4 is a view for explaining an example of processing of generating a regression analysis model in which effects of noises and outliers are reduced in the embodiment. A graph 230 is performance data indicating relationships between the application performance information and the infrastructure performance information in the same time series as that in the graph 210. The vertical axis represents the response time in the application performance information, and the horizontal axis represents the disk queue length in the infrastructure performance information. This processing is executed by an analysis device which analyzes the performance information.

In order to reduce the effects of noises in the regression analysis, the analysis device divides a region between the maximum value and the minimum value of the application performance information into multiple regions at equal intervals. In the graph 230, the region between the maximum value and the minimum value of the application performance information is divided into 10 regions at equal intervals. Note that the number of division is not limited to a certain number.

Thereafter, the analysis device calculates a mean value of multiple pieces of performance data included in each divided region. In a graph 240, the mean value of each divided region in the graph 230 is indicated by a symbol of triangle. Note that a median value may be used instead of the mean value.

FIG. 5 is a view for explaining an example of a regression analysis result obtained by using the mean value in each divided region. A graph 250 depicts a regression analysis result 251 obtained by performing regression analysis using the mean value in each divided region. Since the mean value in each divided region is used as the performance data in the regression analysis result 251, the effects of outliers and noises are reduced.

For example, as described in FIG. 2, the correlation between the time-series data 201 of the application performance information and the time-series data 202 of the infrastructure performance information is apparently high. However, since the data includes noises and outliers, the regression analysis result 211 is unable to express the correlation between the pieces of the performance data well as depicted in the graph 250. Particularly, since the number of pieces of data in the application performance information in a normal time (a time period in which no delay of processing is occurring) is great, the regression analysis result 211 is greatly affected by the pieces of data in this time period.

Meanwhile, the regression analysis result 251 obtained by using the mean value of each divided region accurately expresses the correlation between the pieces of the performance data particularly in the occurrence of performance degradation. Particularly, since pieces of data in the application performance information in the normal time (the time period in which no delay of processing is occurring) are aggregated to the mean value, the degree of effects on the regression analysis is reduced. Meanwhile, the number of pieces of data in a period of the occurrence of performance degradation (in a time period in which delay of processing is occurring) is originally small, and the degree of effects on the regression analysis does not change greatly when these pieces of data are aggregated to the mean value. As a result, in the embodiment, it is possible to perform the processing of reducing the effects of noises on the regression analysis and extract and model the correlation with high accuracy.

A graph 260 illustrates a threshold (32) which is the disk queue length in the infrastructure performance information and which is set based on the regression analysis result 211 and a threshold (20) which is the disk queue length in the infrastructure performance information and which is set based on the regression analysis result 251. When the infrastructure performance information is monitored by using the threshold (32) based on the regression analysis result 211, detection of the disk queue length exceeding the threshold has low accuracy, and the detection is made only at three points in the example of the graph 260. Meanwhile, when the infrastructure performance information is monitored by using the threshold (20) based on the regression analysis result 251, the number of disk queue lengths exceeding the threshold increases and the accuracy becomes higher.

By modeling the infrastructure performance information having high correlation with the application performance information with high accuracy as described above, an optimal threshold of the infrastructure performance information may be selected in the monitoring of the application performance. Moreover, in the pieces of performance data using the mean value in each divided region, noises and outliers are removed and this increases the correlation coefficient between the pieces of performance data, compared to the correlation coefficient before the removal. Accordingly, the infrastructure performance information is more likely to be selected for the monitoring of the application performance.

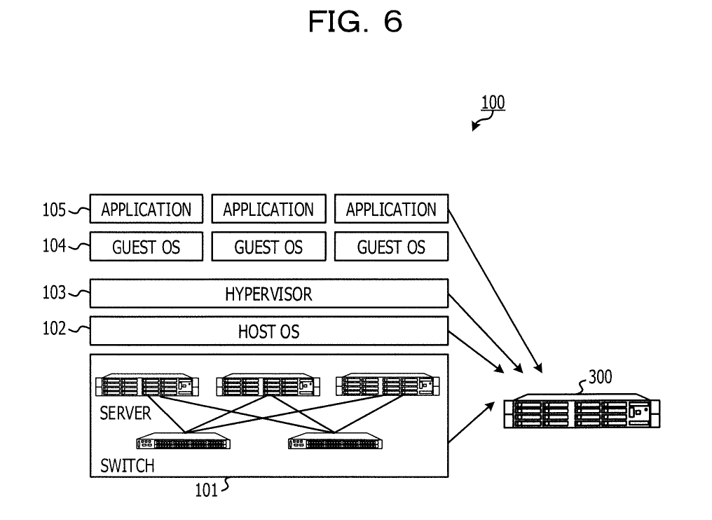

FIG. 6 is a view for explaining an example of a system configuration in the embodiment. The application performance information and the infrastructure performance information in the virtualized infrastructure system 100 are transmitted to an analysis device 300.

The application performance information is measured by the application operating on the guest OS (for example, a virtual OS). For example, in the guest OS, information other than the response time such as the number of transactions per unit time (throughput or the like) may be measured and stored as the performance information. The stored application performance information is periodically transmitted to the analysis device 300.

The infrastructure performance information is performance information collectable from the servers and switches included in the hardware group 101 and performance information collectable from the host OS 102 and the hypervisor 103. The performance information from the host OS 102 and the hypervisor 103 is transmitted to the analysis device 300 via an API provided by the OS and the like. The performance information on the servers, the switches, and the like are sent to the analysis device 300 by using a simple network management protocol (SNMP) and the like.

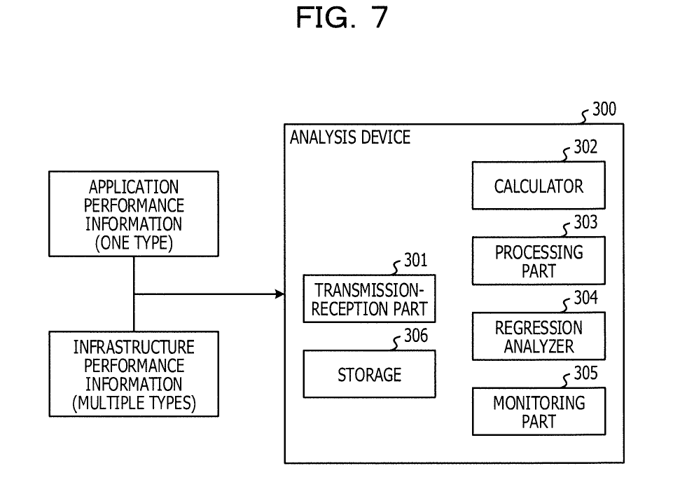

FIG. 7 is a view for explaining examples of functional blocks of the analysis device. The analysis device 300 collects one type of application performance information and multiple types of infrastructure performance information. In the embodiment, the analysis device 300 selects the infrastructure performance information suitable for monitoring the one type of application performance information, from the multiple types of infrastructure performance information.

A transmission-reception part 301 receives the one type of application performance information and the multiple types of infrastructure performance information. A calculator 302 calculates a correlation coefficient between the application performance information and each of the multiple types of infrastructure performance information. A processing part 303 firstly excludes the infrastructure performance information whose correlation coefficient is, for example, 0.3 or less, from a processing target. The processing speed may be increased by excluding the infrastructure performance information whose correlation with the application performance information is low, from the processing target.

The processing part 303 divides a region between the maximum value and the minimum value of the application performance information into multiple regions at equal intervals, and obtains a mean value of pieces of performance data included in each of the divided regions. The calculator 302 calculates the correlation coefficient between the application performance information and the infrastructure performance information by using the obtained mean values.

A regression analyzer 304 selects the infrastructure performance information whose correlation coefficient, calculated by using the mean values, with the application performance information is high. The regression analyzer 304 performs regression analysis by using the mean values of the pieces of performance data of the selected infrastructure performance information and the application performance information.

A monitoring part 305 selects one type of infrastructure performance information for monitoring the one type of application performance information, based on the regression analysis result, and sets a threshold. The actual monitoring of the threshold may be executed by a server monitoring the infrastructure performance information, instead of the analysis device 300.

A storage 306 stores various types of data used in the processing in the calculator 302, the processing part 303, the regression analyzer 304, the monitoring part 305, and the like.

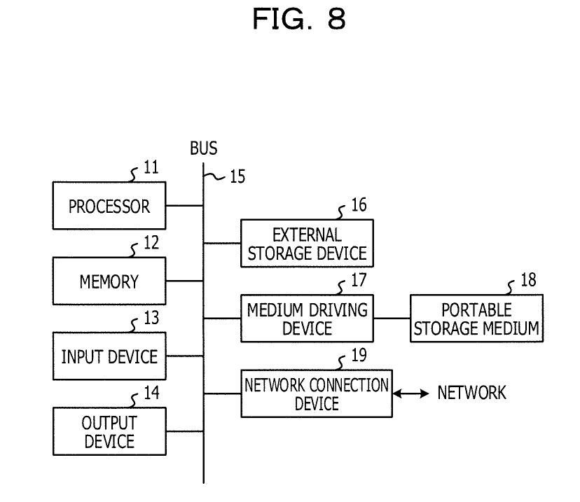

FIG. 8 is a view for explaining an example of a hardware configuration of the analysis device. The analysis device 300 includes a processor 11, a memory 12, a bus 15, an external storage device 16, and a network connection device 19. Furthermore, the analysis device 300 may optionally include an input device 13, an output device 14, and a medium driving device 17. The analysis device 300 is implemented, for example, by a computer or the like.

The processor 11 may be any processing circuit including a central processing unit (CPU). The processor 11 operates as the calculator 302, the processing part 303, the regression analyzer 304, and the monitoring part 305. Note that the processor 11 may execute programs stored in, for example, the external storage device 16. The memory 12 operates as the storage 306. Moreover, the memory 12 stores data obtained by operations of the processor 11 and data used in processing by the processor 11 as desired. The network connection device 19 operates as the transmission-reception part 301 and operates by being used for communication with other devices. The input device 13 is implemented as, for example, buttons, a keyboard, a mouse, and the like. The output device 14 is implemented as a display and the like. The bus 15 connects processor 11, the memory 12, the input device 13, the output device 14, the external storage device 16, the medium driving device 17, and the network connection device 19 to one another such that data may be exchanged among these devices. The external storage device 16 stores programs and data and provides stored information to the processor 11 and the like as desired. The medium driving device 17 may output the data in the memory 12 and the external storage device 16 to a portable storage medium 18 and read programs, data, and the like from the portable storage medium 18. The portable storage medium 18 may be any storage medium capable of being carried, including a floppy disk, a magnet-optical (MO) disk, a compact disc recordable (CD-R), and a digital versatile disc recordable (DVD-R).

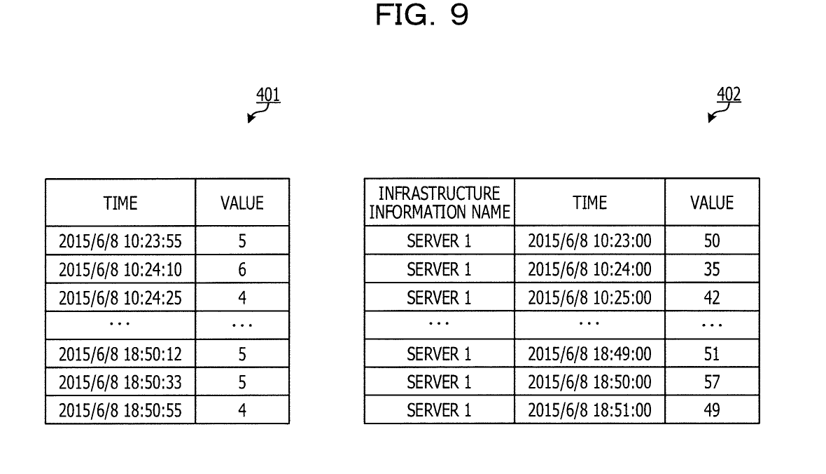

FIG. 9 is a view for explaining an example of contents of the application performance information and the infrastructure performance information. The analysis device 300 obtains times and values corresponding to the times as an application performance information (for example, response time) table 401.

The analysis device 300 obtains the multiple types of infrastructure information. An infrastructure performance information table 402 is obtained for each type of infrastructure performance information. The infrastructure performance information table 402 includes infrastructure information names, times, and values corresponding to the times. The infrastructure information names are names of the types of the infrastructure performance information. For example, server 1 CPU usage is a CPU usage of a server with a server ID of 1.

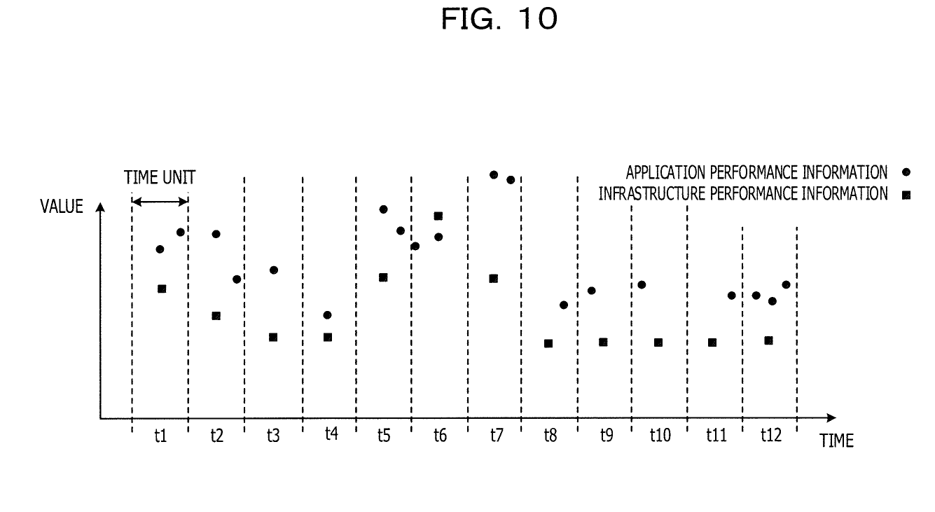

FIG. 10 is a view for explaining an example of processing of generating a data pair of the application performance information and the infrastructure performance information. As in the graph 250, values of the application performance information and the infrastructure performance information at the same time are used for the performance data obtained by associating the application performance information and the infrastructure performance information with each other. However, the time included in the application performance information table 401 and the time included in the infrastructure performance information table 402 may not be the same time. Accordingly, the performance data of the application performance information and the performance data of the infrastructure performance information are associated with each other by using pieces of performance data obtained at times close to each other as illustrated in FIG. 10.

For example, as processing of generating the data pair, the processing part 303 of the analysis device 300 divides the time-series data of the application performance information and the infrastructure performance information into certain time units such as t₁ to t₁₂. The processing part 303 of the analysis device 300 calculates a median value of multiple pieces of performance data of the application performance information included in each time unit (t₁ to t₁₂) and calculates a median value of multiple pieces of performance data of the infrastructure performance information included in each time unit (t₁ to t₁₂). The processing part 303 of the analysis device 300 associates the medium value of the performance data of the application performance information and the medium value of the performance data of the infrastructure performance information with each other as the data pair.

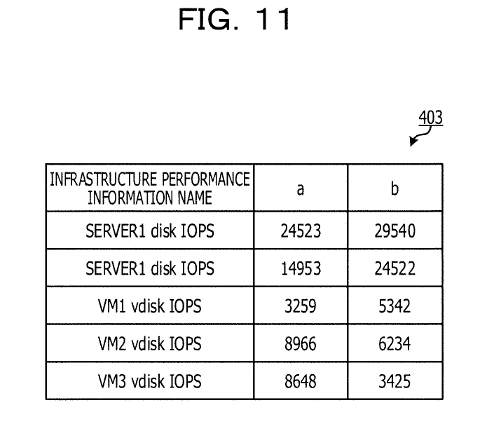

FIG. 11 is a view for explaining an example of the regression analysis result. The regression analysis result 251 of FIG. 5 is expressed as a formula 1 of a linear function:

Value of application performance information=a×value of infrastructure performance information+b (formula 1).

The storage 306 stores a coefficient a and a coefficient b of the linear function in the formula 1 and the infrastructure performance information name used in the regression analysis, as a regression analysis result table 403.

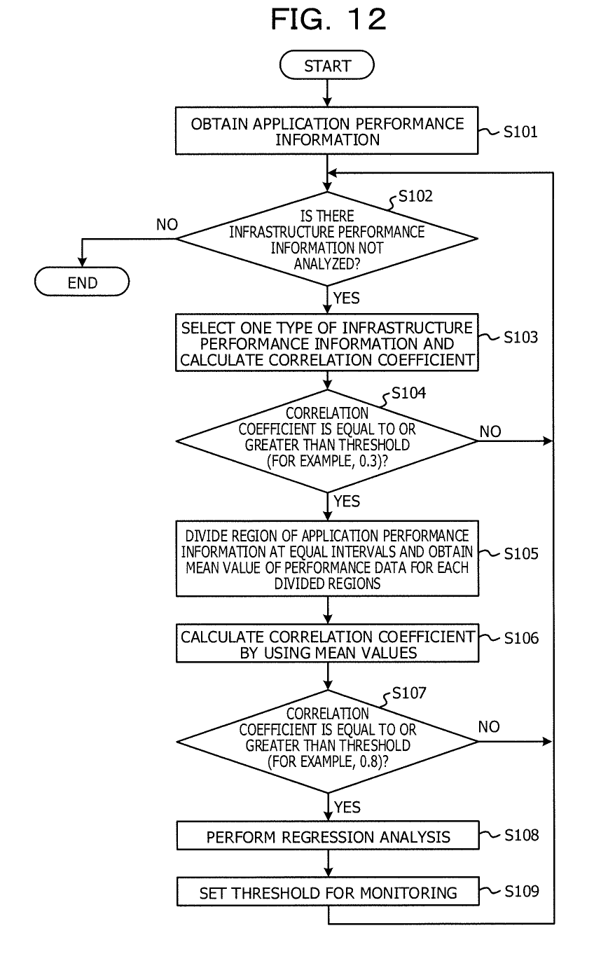

FIG. 12 is a flowchart for explaining an example of processing of the analysis device. The transmission-reception part 301 obtains the application performance information specified by the infrastructure manager (step S101). The processing part 303 determines whether there is infrastructure performance information for which no analysis processing is executed in association with the obtained application performance information (step S102). When there is infrastructure performance information for which no analysis processing is executed (YES in step S102), one type of infrastructure performance information for which no analysis processing is executed is selected, and the calculator 302 calculates the correlation coefficient between the selected infrastructure performance information and the application performance information (step S103).

The processing part 303 determines whether the correlation coefficient calculated in step S103 is equal to or greater than a predetermined threshold (for example, 0.3) (step S104). When the correlation coefficient calculated in step S103 is smaller than the predetermined threshold (NO in step S104), the processing part 303 excludes the selected infrastructure performance information from the analysis target and repeats the processing from step S102. When the correlation coefficient calculated in step S103 is equal to or greater than the predetermined threshold (YES in step S104), the processing part 303 divides the region between the maximum value and the minimum value of the application performance information into multiple regions at equal intervals, and obtains the mean value of pieces of performance data included in each divided region (step S105). The calculator 302 calculates the correlation coefficient between the application performance information and the infrastructure performance information, by using the obtained mean values (step S106). The processing part 303 determines whether the correlation coefficient calculated in step S106 is equal to or greater than a predetermined threshold (for example, 0.8) (step S107).

When the calculated correlation coefficient is equal to or greater than the predetermined threshold (YES in step S107), the regression analyzer 304 performs the regression analysis by using the mean values of pieces of performance data of the infrastructure performance information and the application performance information (step S108). Based on the regression analysis result, the monitoring part 305 selects one type of infrastructure performance information for monitoring the one type of application performance information, and sets the threshold (step S109).

When the processing of step 109 is completed, the processing part 303 of the analysis device 300 repeats the processing from step S102. When the calculated correlation coefficient is not equal to or greater than the predetermined threshold (NO in step S107), the processing part 303 repeats the processing from step S102. When there is no infrastructure performance information for which no analysis processing is executed (NO in step S102), the analysis device 300 terminates the analysis processing.

In the embodiment, by executing the processing described above, the processing of reducing the effects of noises in the regression analysis is performed, and the correlation is extracted and modeled with high accuracy. In the embodiment, the infrastructure performance information optimal for the performance monitoring of the application may be thereby selected from the multiple pieces of infrastructure performance information.

<Others>

In FIG. 4, the region between the maximum value and the minimum value of the application performance information is divided into the predetermined number of regions. However, other methods may be used as the method of determining the regions.

As another method of determining the regions, region intervals of the application performance information may be specified. For example, it is possible to perform region division by using a method in which the mean value of the application performance information is calculated and a value equal to one tenth of the calculated mean value is specified as the region intervals.

Moreover, as yet another method of determining the regions, the number of mean values to be obtained may be specified. In this case, the number of divided regions is determined as follows.

(1) The number of mean values to be obtained is determined. For example, the number of mean values to be obtained is inputted by the infrastructure manager by using the input device.

(2) The analysis device 300 temporarily sets a variable N.

(3) The analysis device 300 calculates the number of mean values obtained when the region between the maximum value and the minimum value of the application performance information is divided into N regions. When there is no performance data in each of the divided regions, the mean value is not obtained in some cases.

(4) When the number of mean values is 30 or more, the analysis device 300 determines the divided number to be N. (5) When the number of mean values is 30 or less, the analysis device 300 adds 1 to the variable N and repeats the processing from (3).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A monitoring apparatus comprising:
a memory; and
a processor coupled to the memory and configured to:
obtain a plurality of first measurement results relating to a first performance of an application when the application is executed by using an infrastructure,
obtain a plurality of second measurement results relating to a second performance of the infrastructure when the application is executed by using the infrastructure, the plurality of second measurement results being associated with the plurality of first measurement results respectively,
classify the plurality of first measurement results into a plurality of groups, based on values of the first performance,
determine, for each of the plurality of groups, a first mean value of one or more of the plurality of first measurement results which are included in the group, and determine a second mean value of one or more of the plurality of second measurement results which are associated with the one or more first measurement results included in the group,
execute regression analysis based on a plurality of the first mean values and a plurality of the second mean values for the plurality of groups, and
monitor the first performance of the application based on the second measurement results of the second performance, according to a result of the regression analysis.

2. The monitoring apparatus according to claim 1, wherein the processor is further configured to:
determine a correlation coefficient between the first performance and the second performance based on the plurality of first mean values and the plurality of second mean values, and
determine the second performance as a monitoring target when the determined correlation coefficient is equal to or greater than a threshold.

3. The monitoring apparatus according to claim 1, wherein the processor is configured to:
determine a first threshold of the first performance based on the result of the regression analysis,
determine a second threshold of the second performance corresponding to the first threshold of the first performance, based on the result of the regression analysis, and
monitor the first performance of the application based on the second measurement results and the second threshold of the second performance.

4. The monitoring apparatus according to claim 1, wherein the infrastructure includes a server which executes the application.

5. The monitoring apparatus according to claim 4, wherein the infrastructure further includes at least one of a host operational system and a hypervisor which operate on hardware including the server.

6. The monitoring apparatus according to claim 1, wherein the first performance is at least one of a response time and a throughput.

7. The monitoring apparatus according to claim 4, wherein the second performance is at least one of a usage of a processor included in the server and a network throughput.

8. A method of monitoring a first performance of an application, the method comprising:
obtaining a plurality of first measurement results relating to a first performance of the application when the application is executed by using an infrastructure;
obtaining a plurality of second measurement results relating to a second performance of the infrastructure when the application is executed by using the infrastructure, the plurality of second measurement results being associated with the plurality of first measurement results respectively;
classifying the plurality of first measurement results into a plurality of groups, based on values of the first performance;
determining, for each of the plurality of groups, a first mean value of one or more of the plurality of first measurement results which are included in the group, and determining a second mean value of one or more of the plurality of second measurement results which are associated with the one or more first measurement results included in the group;
executing regression analysis based on a plurality of the first mean values and a plurality of the second mean values for the plurality of groups; and
monitoring the first performance of the application based on the second measurement results of the second performance, according to a result of the regression analysis.

9. The method according to claim 8, further comprising:
determining a correlation coefficient between the first performance and the second performance based on the plurality of first mean values and the plurality of second mean values; and
determining the second performance as a monitoring target when the determined correlation coefficient is equal to or greater than a threshold.

10. The method according to claim 8, further comprising:
determining a first threshold of the first performance based on the result of the regression analysis; and
determining a second threshold of the second performance corresponding to the first threshold of the first performance, based on the result of the regression analysis, wherein
the monitoring is executed based on the second measurement results and the second threshold of the second performance.

11. The method according to claim 8, wherein the infrastructure includes a server which executes the application.

12. The method according to claim 11, wherein the infrastructure further includes at least one of a host operational system and a hypervisor which operate on hardware including the server.

13. The method according to claim 8, wherein the first performance is at least one of a response time and a throughput.

14. The method according to claim 11, wherein the second performance is at least one of a usage of a processor included in the server and a network throughput.

15. A non-transitory computer-readable storage medium storing a program that causes an information processing apparatus to execute a process, the process comprising:
obtaining a plurality of first measurement results relating to a first performance of a application when the application is executed by using an infrastructure;
obtaining a plurality of second measurement results relating to a second performance of the infrastructure when the application is executed by using the infrastructure, the plurality of second measurement results being associated with the plurality of first measurement results respectively;
classifying the plurality of first measurement results into a plurality of groups, based on values of the first performance;
determining, for each of the plurality of groups, a first mean value of one or more of the plurality of first measurement results which are included in the group, and determining a second mean value of one or more of the plurality of second measurement results which are associated with the one or more first measurement results included in the group;
executing regression analysis based on a plurality of the first mean values and a plurality of the second mean values for the plurality of groups; and
monitoring the first performance of the application based on the second measurement results of the second performance, according to a result of the regression analysis.

16. The non-transitory computer-readable storage medium according to claim 15, the process further comprising:
determining a correlation coefficient between the first performance and the second performance based on the plurality of first mean values and the plurality of second mean values; and
determining the second performance as a monitoring target when the determined correlation coefficient is equal to or greater than a threshold.

17. The non-transitory computer-readable storage medium according to claim 15, the process further comprising:
determining a first threshold of the first performance based on the result of the regression analysis; and
determining a second threshold of the second performance corresponding to the first threshold of the first performance, based on the result of the regression analysis, wherein
the monitoring is executed based on the second measurement results and the second threshold of the second performance.

18. The non-transitory computer-readable storage medium according to claim 15, wherein the infrastructure includes a server which executes the application.

19. The non-transitory computer-readable storage medium according to claim 18, wherein the infrastructure further includes at least one of a host operational system and a hypervisor which operate on hardware including the server.

20. The non-transitory computer-readable storage medium according to claim 15, wherein the first performance is at least one of a response time and a throughput.
